(19) United States
(12) Patent Application Publication
(10) Pub. No.: US 2002/0034955 A1
(43) Pub. Date: Mar. 21, 2002

(54) SELECTIVE RADIO PAGING RECEIVER

(76) Inventor: YASUNORI KOBAYASHI, SHIZUOKA (JP)

Correspondence Address: PAUL J ESATTO JR, SCULLY SCOTT MURPHY & PRESSER, 400 GARDEN CITY PLAZA, GARDEN CITY, NY, 11530

(21) Appl. No.: 09/256,911

(22) Filed: Feb. 24, 1999

(30) Foreign Application Priority Data
Feb. 26, 1998 (JP) 045477/1998

(51) Int. Cl. G05B 19/02; H04Q 7/20

(52) U.S. Cl. 455/458; 340/825.22

(57) ABSTRACT

To facilitate search, red-out, and display of messages which have not been accessed yet, by using a prescribed attribute mark. To the messages is given an attributes which indicate that they have not yet been accessed. The messages are stored as non-accessed messages in a memory in the order of reception, when the call notifications are stopped automatically by a timer. Likewise, received messages are stored in the memory as accessed messages, when the call notifications are stopped by a manual reset switch. Both of the accessed and non-accessed messages are read out in the reverse order of reception, and are displayed in a form of list on a display unit. Further, only one of the messages selected by the display switch is displayed together with its reception time. Therefore, a plurality of messages and their reception times are confirmed at one time on the display.

### BACKGROUND OF THE INVENTIOPN

1. Technical Field of the Invention

The present invention relates to a selective radio paging receiver and particularly, to its display function for received messages.

2. Description of the Prior Art

Conventionally, selective radio paging receivers preserve past paging contents such as dates and messages, read out and display them in the order of reception. Accessed messages and non-accessed messages are mixed on a display unit. Therefore, it takes time and is annoying to select one of the non-accessed messages or the messagaes which have not yet been accessed and confirm their contents, particularly in selective radio paging receiver with large capacity memory.

Therefore, it is expected to read out and display easily the non-accessed messages, because messages which are transmitted toward radio paging receivers are often urgent and important.

For example, there is disclosed in JP0677880A (1994) a selective call radio receiver with display function wherein messages not yet read out by owners of receivers are read out by easy operation. Therefore, the prioriy or degree of importance of the messages can be judged correctly and easily. The radio receiver as disclosed in JP0677880A (1994) comprises a first function for judging whether a message has already been accessed or not, reading-out only non-accessed messages, and then displaying them, a second function for displaying the non-accessed message for a prescribed time, a third function for displaying a list of messages and their time of reception, and a forth function for displaying a part of each message and its time of reception.

However, the above-mentioned conventional receiver can not read out easily the messages which have been already accessed, although the above-mentioned conventional receiver is useful for non-accessed messages.

There are some important messages among the already read-out messages or un-accessed messages, for example, in case of receiving information such as currency exchange rate or stock price serviced by providers in communication networks. These information change every moment without any period nor notice.

Further, such a business as currency exchange and stock dealing needs a prompt decision and timing. So, up-to-date imformation is vitally required.

Therefore, the conventional system which displays only non-accessed messages is inconvenient, when former information such as market price is not renewed and is to be confirmed again.

### SUMMARY OF THE INVENTION

Therefore, an object of the present invention is to improve the above-mentioned conventional receiver in order to display easily also non-accessed messages or messages of which contents have not been read out yet. Another object of the invention is to display their reception times together with the contents of the messages.

The selective radio paging receiver of the present invention receives a selective call signal and message signal, and notifies the reception of the call signal. It comprises a memory for storing the received message, an automatic and manual reset means for stopping the notification of call signal reception, a memory control means which gives an attribute indicating that the message is a non-accessed message in an automatic reset mode, and stores non-accessed messages in the automatic reset mode and accessed messages in the manual reset mode together with their time of reception, and a display control means for display a list of the non-accessed and accessed messages in the reverse order of reception.

Further, the receiver of the present invention comprises a scroll means for selecting one of the messages accessed or non-accessed and its reception time.

The display control means as mentioned-above further displays the messages and its reception times by using prescribed formats.

Further, the display control means displays the reception time of the message selected by the scroll means and a list of contents of messages both selected and not-selected.

Further, the receiver of the present invention comprises a enlarged display means for displaying a content of the selected message by using enlarged characters.

In the enlarged display as mentioned-above, the content of the selected message is displayed in a plurality of lines, while the reception time of the selected message is displayed in the area different from the content display area without enlarging the size of character.

Furthermore, the attribute of the non-accessed massage which is selected and displayed by the enlarged display means is deprived to store the selected message as an accessed message.

According to the present invention, a prescribed attribute is given to the received messages in order to indicate that they are non-accessed messages or messages not yet read out, and are stored in the memory means in the order of reception, when the call notifications are stopped by the automatic reset means. Likewise, the received messages are stored in the memory means as accessed messages, when the call notifications are stopped by the manual reset means. Both of the accessed and non-accessed messages in the memory means are read out in the reverse order of reception, and are displayed in a form of list. Further, only one of the messages selected from the list is displayed together with its reception time by enlarged characters. Therefore, a plularity of messages and their reception times are confirmed at one time on the above-mentioned display.

Further, it is easy to know whether a message is accessed, or non-accessed, even when accessed and non-accessed messages are mixed in a display. This is because the attribute mark is attached only to the non-accessed messages.

Further, it is easy to read the contents of messages, owing to the enlarged display.

Furthermore, the degree of emergency and importance of non-accessed messages can be immediately judged, because it is also easy to confirm the reception times.

### BRIEF EXPLANATION OF THE DRAWINGS

FIG. 1 is a block diagram of a selective radio paging receiver of the present invention.

FIG. 2 is a flow chart for explaining the reception and display of messages.

FIG. 3A is a list display in the first exemplary display of message.

FIG. 3B is an enlarged display in the first exemplary display of message.

FIG. 3C is another list display in the first exemplary display of message, when one of the non-accessed message is deprived of its attribute, enlarged for display, and is further display in a list.

FIG. 4A is a list display in the second exemplary display of message.

FIG. 4B is an enlarged display in the second exemplary display of message.

FIG. 4C is another list display in the second exemplary display of message, when one of the non-accessed message is deprived of its attribute, enlarged for display, and is further display in a list.

### PREFERRED EMBODIMENT OF THE INVENTION

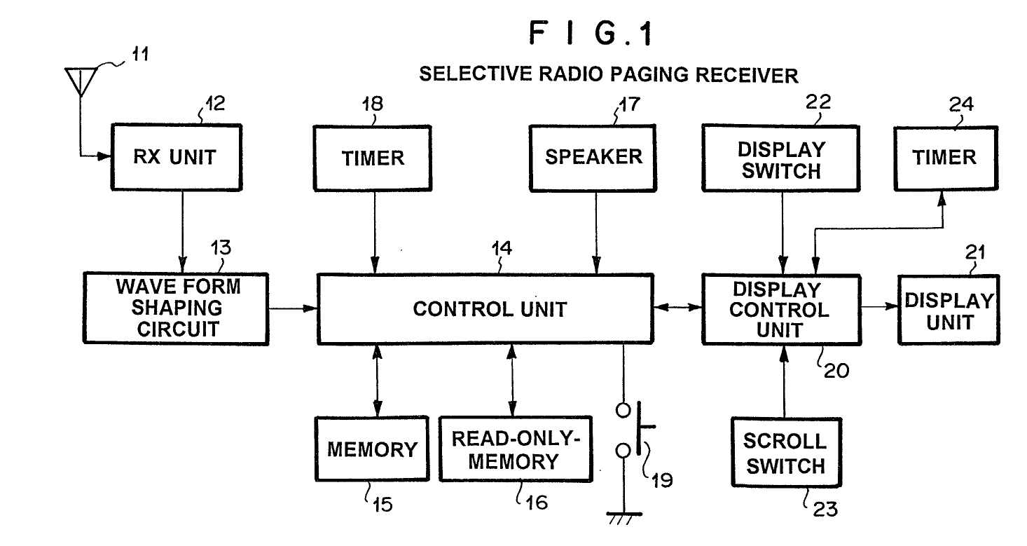

Referring to the drawings, a mode of embodiment of the present invention is explained. FIG. 1 is a block diagram of a selective radio paging receiver of the present invention.

As shown in FIG. 1, selective radio paging receiver 10 of the present invention comprises antenna 11, RX 12 for receiving, amplifying, and demodulating radio signals, wave form shaping circuit 13 for converting the demodulated signals into digital signals, memory 15 for storing messages and reception time in the sequential order of reception, read-only-memory 16 for storing a call number of the receiver itself, speaker 17, timer 18 for counting a prescribed time for paging, manual reset switch 19 for stopping the sound of speaker 17, display control unit 20 for controlling the display of the messages and the reception time which are read out from memory 15, display unit 21 for displaying prescribed number of words and lines, for example, 22 words in each of 5 lines, or 11 words in each of 3 lines, display switch 22 for enlarging the messages, scroll switch 23 for selecting messages, display timer 24 for displayin for a prescribed time interval, ccontrol unit 14 for controlling the whole receiver.

Control unit 14 compares the call number received by the receiver with the call number stored in read-only-memory 16, and drives speaker 17 to inform an arrival of message, on the basis of the number identification.

The sound may be reset automatically or manually. Automatic reset is implemented by control unit 14 which starts up timer 18 at the beginning of ringing, and detects the time out, while manual reset is implemented by manual reset switch 19.

Received messages together with their reception times are stored as non-accessed messages in memory 15 under the automatic reset mode, while they are stored as accessed messages together with their reception times in memory 15.

Accordingly, non-accessed and accessed messages are stored in the sequential order as they are received. Only the non-accessed messages are given an attribute which indicates that they are non-accessed messages.

Display control unit 20 reads out a prescribed number of the messages in the reverse order of reception, without referring to the given attribute, and make display unit 21 display a message list accompanied with the given attributes. Here, it is assumed as an example that four messages are displayed in four lines using 22 words per line.

Scroll switch 23 selects one of the displayed four messages by using cursor display. The list of the fifth to eigth earlier messages may be also displayed. Thus, a desired set of four messages are listed on the display and one of the messages is selected by the cursor.

Non-accessed messages are easily selected, because they are given the attributes. Therefore, accessed messages are easily read out repeatedly and are easily confirmed.

Further, the message which is selected by scroll switch 23 is enlarged on display 21, by display switch 22. The enlarging display of the message may be 11 capital letters in 2 lines accompanied by its reception time in a remaining line. Then, the enlarged message is deprived of its attribute and is stored as an accessed message.

The operation of display switch 22 causes timer 24 to start to restore the list on the basis of the timeout.

In case of the manual reset, the received messages are enlarged, and are treated as accessed messages. On the basis of the timeout of timer 24, the enlarging display is replaced by the list display.

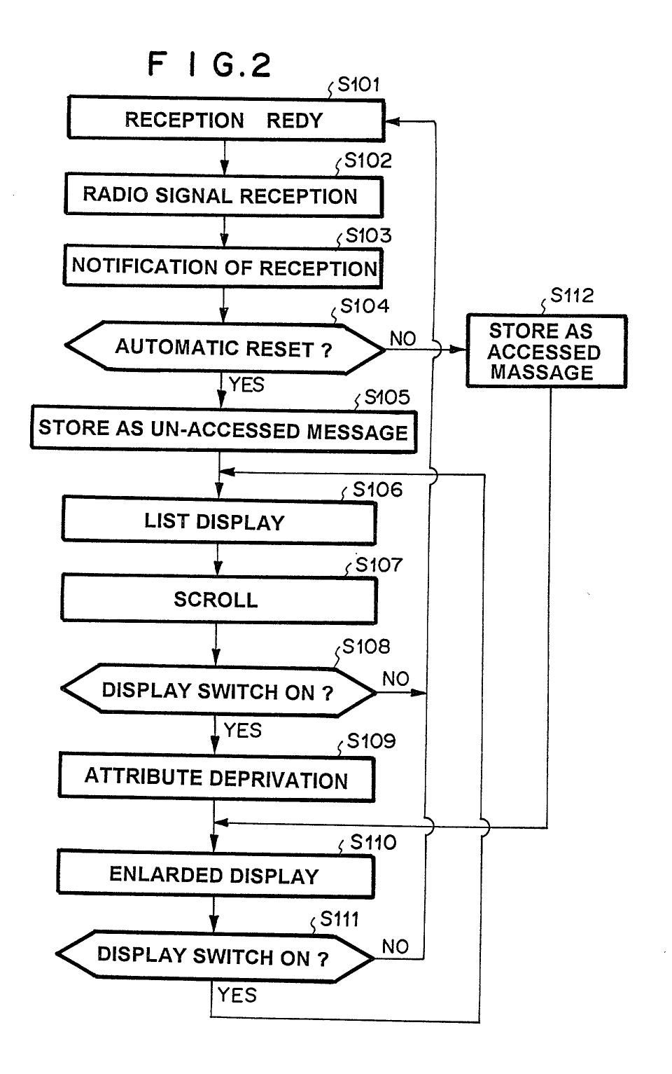

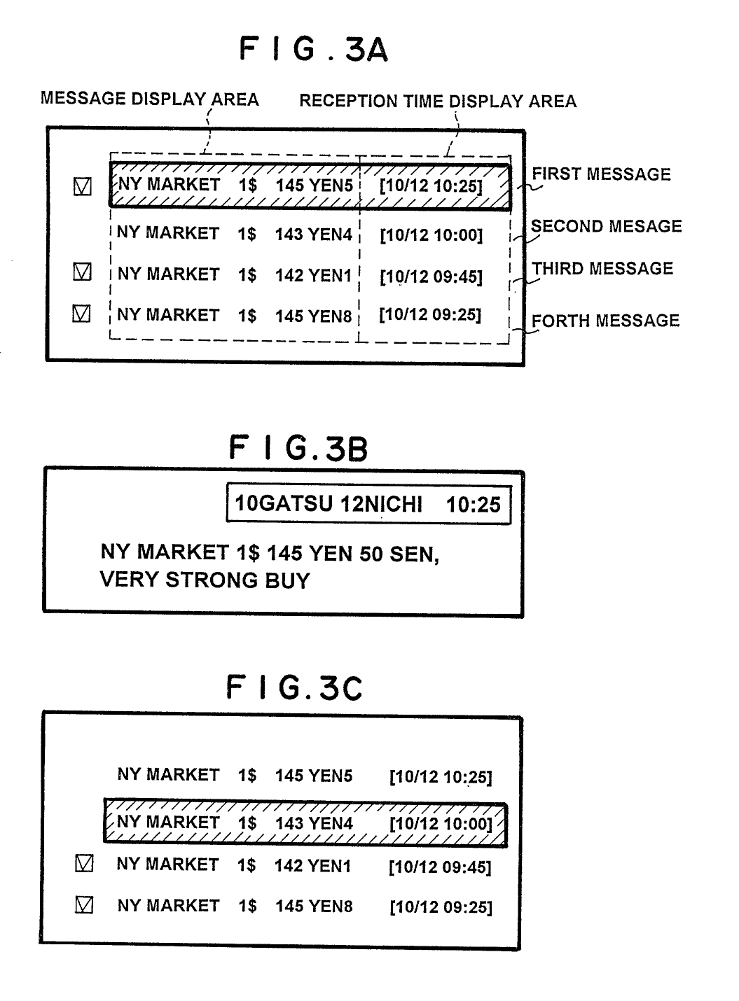

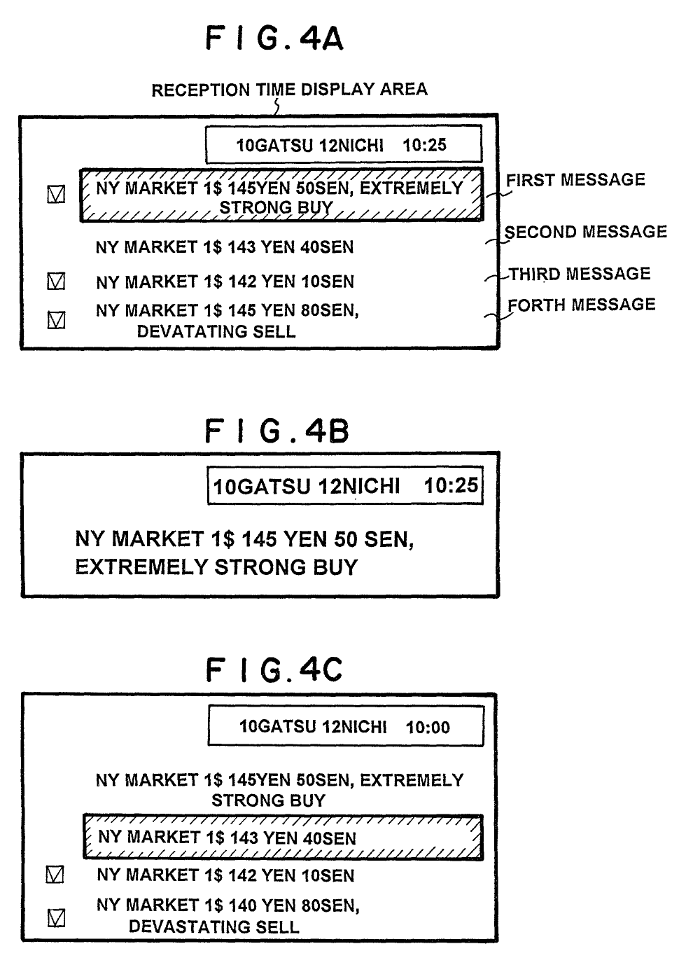

FIG. 2 is a flow chart for explaining the receiving and displaying radio messages. FIG. 3 is an exemplary display of messages. FIG. 4 is another exemplary display of the radio messages.

When selective radio paging receiver 10 is in a waiting state (S101), RX 12 receives and demodulate radio signals through antenna 11 (S102).

Control unit 14 compares the call number stored in read-only-memory 16 and the call number included in the demodulated signal which is converted to a digital signal by wave form shaping circuit 13. If the numbers are identical, control unit 14 sends out a call signal toward speaker 17 to notify a reception of message (S103) and starts up timer 18.

Control unit 14 recognizes the manual reset mode by detecting an operation of manual reset switch 19 before the timeout of timer 18 (S104), thereby stores the received message in memory 15 as an accessed message (S112), and then displays it in the enlarged format (S110).

Further, control unit 14 orders display control unit 20 to start up timer 24.

On the other hand, control unit 14 recognizes the automatic reset mode by detecting the timeout of timer 18 before an operation of manual reset switch 19, thereby stores the received message in memory 15 as a non-accessed message which is given the attribute (S105).

The list display in case of the automatic rest mode is such that contents and reception times of four messages stored in memory 15 are displayed in the four lines each of which contains a content and reception time of each message (S106), as shown in FIG. 3A. The contents which includes more than prescribed number of words is displayed partially. The four sets of messages stored in memory 15 is displayed on display 21 in the reverse order of reception without regard to whether accessed or non-accessed.

As shown in FIG. 3A, the first, third, and forth messages have not yet been accessed, while the second message has been already accessed. Here, the first message is the newest one.

When one of these messages is selected by scroll switch 23, display control unit 20 indicates the selected message by using a cursor (S107) and starts up timer 24. As shown in FIG. 3C, the second message is distinguished by the cursor display from the others.

When display switch 22 is turned on before the timeout of timer 24 (S108), then timer 24 is restored again. At the same time, a selected non-accessed message is deprived of its attribute (S109) and is enlarged (S110), as shown in FIG. 3C.

On the other hand, when the timeout of timer 24 is detected before the turn-on of display switch 22 (S108), then the processing step moves to S101, without reading out the message which was selected by scroll switch 23. Then, further, display switch 22 is reset and restored, and the receiver get ready to wait for next radio signal information.

Further, when display switch 22 is turned on again before the timeout of timer 24 (S111), then steps S106, S107, S108, S109, and S110 are repeated.

When the timeout of timer 24 is detected before the turn-on of display switch 22, then the processing step moves to S101 to stop receiving and controlling. When the manual reset by manual reset switch 19 is detected before the timeout of timer 18 (S104), then the accessed message which is stored in memory 15 (S112) is enlarged on display 21 (S110).

In step S111, when the timeout of timer 24 is detected, then the processing step moves to S101, and the receiver gets ready to wait for next radio signal information. Also in step S111, when display switch 22 is turned on before the timeout of timer 24, then the processing step moves to S106 to repeat steps S107, S108, S109, and S110.

Of course, when the timeout of timer 24 is detected before the turn-on of display switch 22 in step S111, then the processing step moves to S101, and the receiver gets ready to wait for next radio signal information.

Next, referring to FIGS. 3A to 3C, the displays of messages are explained. FIGS. 3A, 3B, and 3C are first exemplary displays of contents of messages and their reception times. FIG. 3A is a list display, wherein a message display area is assigned on the left hand side and a reception time display area is assigned on the right hand on each line. The first line contains the newest message, and the second line contains the second newest message. The attributes or check marks are given on the left edge, which indicate that the first, third, and forth messages have not been accessed yet. The list display is dispalyed in step S106 as shown in FIG. 2.

The enlarged display as shown in FIG. 3B is executed, when display switch 22 is turned on in step S111.

The cursor selection display as shown in FIG. 3C is executed, when scroll switch 23 selects the second newest message in step S106, after the execution of the enlarged display of the first message. Users realize by seeing the cursor selection display that the newest message in the first line is deprived of the attribute and is stored as an accessed message.

Thus, a non-accessed message is deprived of its attribute and is stored as an accessed message.

FIGS. 4A to 4C are second exemplary displays, wherein a list of contents of messages are collected in a message display area and only the reception time of which message is selected by scroll switch 23 is displayed in a reception time display area.

The message in the first line in the message display area as shown in FIG. 4A is of course the newest one, and the second is the second newest. Further the first, third, and forth messages are checked by the attribute mark. The whole display is a list display executed in step S106.

The message display area is expanded by limiting the number of reception times to be displayed and by displaying the reception times separately.

FIG. 4B is an enlarged display of the newest mesage selected by the turn-on of display switch 22 executed in step S111.

The cursor selection display as shown in FIG. 4C is executed, when scroll switch 23 selects the second newest message in step S106, after the execution of the enlarged display of the first message. Users realize by seeing the cursor selection display that the newest message in the first line is deprived of the attribute and is stored as an accessed message.

Although the present invention has been shown and described with respect to the best mode embodiment thereof, it should be understood by those skilled in the art that the foregoing and various other changes, omissions, and additions in the form and detail thereof may be made therein without departing from the spirit and scope of the present invention.

What is claimed is:

1. A selective radio paging receiver wherein messages in radio paging signals are stored, which comprises:
a memory for storing said messages;
an automatic reset means for stopping a notification of reception of one of said radio paging signals;
a manual reset means for stopping a notification of reception of one of said radio paging signals;
a memory control means for giving a prescribed attribute to said messages which have not yet been read out; for storing said message together with their reception times as a message which has not yet been accessed under the activation of said automatic reset means, and for storing said messages together with their reception times as a message which have been already accessed under the activation of said manual rest means; and
a display control means for display a list of the non-accessed and accessed messages in the reverse order of reception.

2. The selective radio paging receiver according to claim 1, which further comprises a scroll means for selecting one of said messages.

3. The selective radio paging receiver according to claim 1, wherein said display control means controls a display of said messages and their reception times by using prescribed formats.

4. The selective radio paging receiver according to claim 2, wherein:
only one of said reception times of said messages which is selected by said scroll means is displayed; and
a list of contents of messages including messages which are not selected by said scroll means are displayed simultaneously.

5. The selective radio paging receiver according to claim 2, which further comprises an enlarged display means for displaying a content of one of said messages selected by said scroll means by using enlarged characters.

6. The selective radio paging receiver according to claim 5, wherein:
said content selected by said scroll means is displayed in a plurality of lines; and
a reception time of said one of said messages selected by said scroll means is displayed without enlarging the size of characters in the area different from the content display area.

7. The selective radio paging receiver according to claim 5, wherein a prescribed attribute of said one of said messages which is displayed by said enlarged display means is deprived to be stored as a message which have been already accessed.

8. A method of selective radio paging which comprises the steps of:
receiving call signals and message signals;
notifying the receptions of said call signals;
storing said message signals;
stopping notifying said receptions automatically or manually;
giving attributes to said message signals which have not been read out yet; and
displaying a list of said message signals together with said attributes and their reception times in the reverse order of said receptions.
